(19) United States
(12) Patent Application Publication
(10) Pub. No.: US 2026/0273978 A1
(43) Pub. Date: Sep. 17, 2026

(54) IMAGE FORMING METHOD AND IMAGE FORMING APPARATUS

(71) Applicants: Toshiyuki KOBASHI, Tokyo (JP); Hiroshi GOTOU, Shizuoka (JP)

(72) Inventors: Toshiyuki KOBASHI, Tokyo (JP); Hiroshi GOTOU, Shizuoka (JP)

(21) Appl. No.: 19/557,120

(22) Filed: Mar. 5, 2026

(30) Foreign Application Priority Data
Mar. 13, 2025 (JP) 2025-040044

(51) Int. Cl. B41M 5/00; B41J 3/54; B41J 11/00; C09D 11/30; C09D 11/54

(52) U.S. Cl. CPC B41M 5/0017; B41J 3/543; B41J 11/0015; C09D 11/30; C09D 11/54

(57) ABSTRACT

An image forming method is provided that includes discharging a pretreatment liquid and an ink onto a recording medium by an inkjet method to form an image. The pretreatment liquid includes an aggregating agent, a landing time difference between a droplet of the pretreatment liquid and a droplet of the ink is 0.05 seconds or more and 2.0 seconds or less, and −5.0 mN/m≤σ1−σ2≤5.0 mN/m is satisfied, where σ1 is a dynamic surface tension of the pretreatment liquid and σ2 is a dynamic surface tension of the ink as measured at 25° C. and a lifetime of 150 ms.

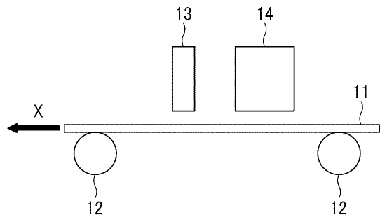

### CROSS-REFERENCE TO RELATED APPLICATIONS

This patent application is based on and claims priority pursuant to 35 U.S.C. § 119 (a) to Japanese Patent Application No. 2025-040044, filed on Mar. 13, 2025, in the Japan Patent Office, the entire disclosure of which is hereby incorporated by reference herein.

### BACKGROUND

### Technical Field

The present disclosure relates to an image forming method and an image forming apparatus.

### Related Art

High-speed printing and high image quality are required of a commercial inkjet image forming apparatus, and a technique of conveying a medium such as paper or a film at high speed and a technique of moving a head that discharges an ink in a scanning manner have been proposed. For such an image forming apparatus, a recording method has been proposed in which a pretreatment liquid including an aggregating agent such as an organic acid or a polyvalent metal salt is applied to a medium in advance, and a pigment included in an ink is aggregated to cause pinning, thereby obtaining a high-quality image on various media.

### SUMMARY

The present disclosure described herein provides an image forming method that includes discharging a pretreatment liquid and an ink onto a recording medium by an inkjet method to form an image. The pretreatment liquid includes an aggregating agent, a landing time difference between a droplet of the pretreatment liquid and a droplet of the ink is 0.05 seconds or more and 2.0 seconds or less, and −5.0 mN/m≤σ1−σ2≤5.0 mN/m is satisfied, where σ1 is a dynamic surface tension of the pretreatment liquid and σ2 is a dynamic surface tension of the ink as measured at 25° C. and a lifetime of 150 ms.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawing, wherein:

the drawing is a schematic diagram illustrating an arrangement example of an image forming apparatus according to an embodiment of the present invention.

The accompanying drawing is intended to depict embodiments of the present disclosure and should not be interpreted to limit the scope thereof. The accompanying drawing is not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The present disclosure described herein provides an image forming method that can suppress color boundary bleeding and text bleeding even in high-speed printing in which a landing time difference between a pretreatment liquid droplet and an ink droplet is within 2 seconds.

In a method in which an image is formed by depositing an ink after applying a pretreatment liquid by an inkjet method, the pretreatment liquid can be uniformly applied irrespective of unevenness on a medium as compared with a conventional roller coating method; therefore, a uniform image can be obtained with various media.

However, when the printing speed is increased in order to improve productivity, the following problem arises: in a region where the landing time difference between the pretreatment liquid and the ink is within 2 seconds, an ink droplet lands before the pretreatment liquid penetrates into the medium, and the ink droplet is thus drawn into a pretreatment droplet before ink droplet aggregation, and a dot is deformed. As one solution for the problem, a time interval from landing of a pretreatment liquid droplet to landing of an ink liquid droplet can be secured by widening the distance between a head that discharges the pretreatment liquid and a head that discharges the ink; however, problem with this solution is that when the distance between the heads is widened, an apparatus size becomes large.

As a result of intensive studies, the inventors of the present invention have found that color boundary bleeding and text bleeding can be suppressed even in high-speed printing when satisfying −5.0 mN/m≤σ1−σ2≤5.0 mN/m, where σ1 is the dynamic surface tension of the pretreatment liquid and σ2 is the dynamic surface tension of the ink as measured at 25° C. and a lifetime of 150 ms.

When the landing time difference is 2.0 seconds or less, an ink droplet lands after droplets of the pretreatment liquid have diffused on a medium plane and before the droplets of the pretreatment liquid have completely penetrated into the medium, and an image is formed in a wet-on-wet manner thereby. Accordingly, all ink droplets are printed on the pretreatment liquid, and the following effect is thus provided: even when different media are used, uniform images with a small difference in image quality are obtained.

On the other hand, when the landing time difference is less than 0.05 seconds, some of droplets of the ink directly land on the medium before droplets of the pretreatment liquid have spread over the medium plane after landing on the medium, and an intended pinning effect cannot be achieved.

An image forming method and an image forming apparatus according to embodiments of the present invention will be described in more detail below.

### Image Forming Method and the Image Forming Apparatus

An image forming method according to embodiments of the present invention is an image forming method to discharge a pretreatment liquid and an ink onto a recording medium by an inkjet method to form an image, the method including a pretreatment liquid jetting step and an ink jetting step, and includes an additional step as necessary.

An image forming apparatus according to embodiments of the present invention is an image forming apparatus including: a head that discharges a pretreatment liquid; and a head that discharges an ink, the image forming apparatus discharging the pretreatment liquid and the ink onto a recording medium by an inkjet method to form an image, with the image forming apparatus including a pretreatment liquid jetting unit and an ink jetting unit and including an additional unit as necessary.

The image forming method according to embodiments of the present invention is suitably carried out by the image forming apparatus according to embodiments of the present invention, and the pretreatment liquid jetting step is suitably carried out by the pretreatment liquid jetting unit, and the ink jetting step is suitably carried out by the ink jetting unit. The additional step is suitably performed by a corresponding additional unit.

### Pretreatment Liquid Jetting Step and Pretreatment Liquid Jetting Unit

The pretreatment liquid jetting step is a step in which a stimulus (energy) is applied to a pretreatment liquid to jet the pretreatment liquid and deposit the pretreatment liquid onto a recording medium.

The pretreatment liquid jetting unit is a unit to apply a stimulus (energy) to the pretreatment liquid to jet the pretreatment liquid and deposit the pretreatment liquid onto the recording medium. The pretreatment liquid jetting unit is not particularly limited, and examples thereof include various nozzles that discharge the pretreatment liquid.

The stimulus (energy) may be generated, for example, by a stimulus generation unit, the stimulus is not particularly limited and may be appropriately selected according to a purpose, and examples thereof include heat (temperature), pressure, vibration, and light. One of these stimuli may be used alone, or two or more thereof may be used in combination.

Among these, heat and pressure are preferable.

Examples of the stimulus generation unit include a heating device, a pressurizing device, a piezoelectric element, a vibration generation device, an ultrasonic oscillator, and a light, and specific examples thereof include a piezoelectric actuator such as a piezoelectric element, a thermal actuator utilizing a phase change due to film boiling of a liquid with an electrothermal conversion element such as a heating resistor, a shape-memory alloy actuator utilizing a metal phase change due to a temperature change, and an electrostatic actuator utilizing an electrostatic force.

The manner of jetting the pretreatment liquid is not particularly limited and varies depending on, for example, the type of the stimulus. For example, in a case where the stimulus is “heat,” a method in which thermal energy corresponding to a recording signal is applied to the pretreatment liquid in a recording head using a thermal head or the like, a bubble is generated in the pretreatment liquid by the thermal energy, and the pretreatment liquid is ejected and jetted as a droplet from a nozzle hole of the recording head by means of the pressure of the bubble is mentioned. In a case where the stimulus is “pressure,” for example, a method in which by applying a voltage to a piezoelectric element bonded to a position referred to as a pressure chamber in a pretreatment liquid flow path in a recording head, the piezoelectric element is deflected, the volume of the pressure chamber is reduced, and the pretreatment liquid is ejected and jetted as a droplet from a nozzle hole of the recording head is mentioned.

### Ink Jetting Step and Ink Jetting Unit

The ink jetting step is a step in which a stimulus (energy) is applied to the ink to jet the ink and deposit the ink onto a recording medium.

The ink jetting unit is a unit to apply a stimulus (energy) to the ink to jet the ink and deposit the ink onto the recording medium. The ink jetting unit is not particularly limited, and examples thereof include various nozzles that discharge the ink.

The stimulus (energy) used in the ink jetting step and the ink jetting unit are the same as that used in the pretreatment liquid jetting step and the pretreatment liquid jetting unit, and description thereof is thus omitted.

### Additional Step and Additional Unit

The additional step is not particularly limited and may be appropriately selected according to a purpose, and examples thereof include a drying step and a control step.

The additional unit is not particularly limited and may be appropriately selected according to a purpose, and examples thereof include a drying unit and a control unit.

### Drying Step and Drying Unit

The drying step is a step in which the recording medium on which an image is recorded with the ink is heated and dried by the drying unit.

The drying unit is not particularly limited, may be appropriately selected according to a purpose, and may be performed by an infrared drying device, a microwave drying device, a roll heater, a drum heater, or hot air, for example. Note that in order to smooth an image-forming surface and fix the image, a fixing step in which a heating unit applies heat to raise the temperature to 100° C. or higher and 150° C. or lower for thermal fixation may be provided.

By providing the fixing step, glossiness and fixability of recorded matter are improved. A roller or drum heater having a heated mirror surface is preferably used as a thermally fixing unit, and a mirror surface portion (smooth portion) of a roll heater or drum heater may be brought into contact with the image-forming surface. As for the heating temperature, a fixing roller heated to 100° C. or higher and 150° C. or lower is preferable in consideration of image quality, safety, and economic efficiency.

### Control Step and Control Unit

The control step is a step in which each of the above-described steps is controlled and is executed by the control unit.

The control unit is not particularly limited as long as the control unit can control the operation of each of the above-described units, and may be appropriately selected according to a purpose, and examples thereof include devices such as a sequencer and a computer.

The drawing is a schematic diagram illustrating an arrangement example of an image forming apparatus according to an embodiment of the present invention. The drawing illustrates a medium 11, a moving conveyor 12, an ink discharge head 13, and a pretreatment liquid discharge head 14.

The arrow X in the diagram indicates the conveying direction of the medium 11 (hereinafter, also simply referred to as the conveying direction), and the pretreatment liquid discharge head 14 is disposed upstream of the ink discharge head 13 in the conveying direction.

Paper, a film, fabric, or the like may be used as the medium 11, for example; however, a roll-type continuous sheet is used in the example illustrated in the drawing.

The ink discharge head 13 discharges an ink droplet onto the recording medium 11, and an inkjet-type head may be used, for example.

The pretreatment liquid discharge head 14 discharges a pretreatment liquid droplet onto the recording medium 11, and an inkjet-type head may be used, for example.

The moving conveyor 12 (also referred to as a moving conveyance mechanism, moving conveyance device, medium conveying mechanism, and the like) relatively moves the ink discharge head 13 and pretreatment liquid discharge head 14 and the medium 11. Although modifications are possible as appropriate, a roller that conveys the medium 11 may be used, for example. Note that although the terms “move” and “convey” are used in the description, these terms are not strictly distinguished from each other unless otherwise specified.

The moving conveyor 12 may move and convey the heads and the media simultaneously or may move and convey either the heads or the media. The moving conveyor 12 in the drawing does not move the ink discharge head 13 and pretreatment liquid discharge head 14 and conveys the medium 11. Such a manner is also referred to as a single-pass method. Embodiments of the present invention are not limited to the single-pass method, and a method in which a head is moved in a scanning manner (also referred to a multi-pass method) is also included.

When the pretreatment liquid is attached onto the medium by an inkjet method, attachment may be performed in a single pass of relative scanning between the head and the medium by using a line-type inkjet head, or may be performed in the multi-pass method with the head and the medium by using a serial-type inkjet head, and either method may be adopted. From the viewpoint of increasing printing speed, a line-type inkjet head is preferably used.

In the line-type method, the ink discharge head 13 and the pretreatment liquid discharge head 14 are incorporated into the image forming apparatus, and by detecting the distance between the ink discharge head 13 and the pretreatment liquid discharge head 14 or the conveyance speed of the medium 11, an ink droplet can be landed onto a region where the pretreatment liquid has been applied.

### Ink

An organic solvent, water, a coloring material, a resin, an additive, and the like used in the ink are described below.

### Organic Solvent

The organic solvent used in the present disclosure is not particularly limited, and a water-soluble organic solvent may be used. Examples thereof include polyhydric alcohols, ethers such as polyhydric alcohol alkyl ethers and polyhydric alcohol aryl ethers, nitrogen-containing heterocyclic compounds, amides, amines, and sulfur-containing compounds.

Specific examples of the water-soluble organic solvent include polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methyl-1,3,5-pentanetriol; polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyhydric alcohol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethylpropionamide, and 3-butoxy-N,N-dimethylpropionamide; amines such as monoethanolamine, diethanolamine, and triethylamine; sulfur-containing compounds such as dimethylsulfoxide, sulfolane, and thiodiethanol; propylene carbonate; and ethylene carbonate.

An organic solvent having a boiling point of 250° C. or lower is preferably used because such an organic solvent not only functions as a wetting agent but also provides good drying properties.

A polyol compound having 8 or more carbon atoms and a glycol ether compound are also preferably used. Specific examples of the polyol compound having 8 or more carbon atoms include 2-ethyl-1,3-hexanediol and 2,2,4-trimethyl-1,3-pentanediol.

Specific examples of the glycol ether compound include polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyhydric alcohol aryl ethers such as ethylene glycol monophenyl ether and ethylene glycol monobenzyl ether.

The polyol compound having 8 or more carbon atoms and the glycol ether compound can improve ink penetration when paper is used as the recording medium.

The content of the organic solvent in the ink is not particularly limited and may be appropriately selected according to a purpose, but is preferably 10% by mass or more and 60% by mass or less, and more preferably 20% by mass or more and 60% by mass or less from the viewpoint of ink drying properties and discharge reliability.

### Water

The content of water in the ink is not particularly limited and may be appropriately selected according to a purpose, but is preferably 10% by mass or more and 90% by mass or less, and more preferably 20% by mass or more and 60% by mass or less from the viewpoint of ink drying properties and discharge reliability.

### Coloring Material

The coloring material is not particularly limited, and a pigment and a dye may be used.

As the pigment, an inorganic pigment or an organic pigment may be used. One kind thereof may be used alone, or two or more kinds thereof may be used in combination. In addition, a mixed crystal may also be used.

As the pigment, for example, a black pigment, a yellow pigment, a magenta pigment, a cyan pigment, a white pigment, a green pigment, an orange pigment, a glossy color pigment such as gold or silver, and a metallic pigment may be used.

As the inorganic pigment, in addition to titanium oxide, iron oxide, calcium carbonate, barium sulfate, aluminum hydroxide, barium yellow, cadmium red, and chromium yellow, carbon black produced by a known method such as a contact method, a furnace method, or a thermal method may be used.

As the organic pigment, an azo pigment, a polycyclic pigment (for example, a phthalocyanine pigment, a perylene pigment, a perinone pigment, an anthraquinone pigment, a quinacridone pigment, a dioxazine pigment, an indigo pigment, a thioindigo pigment, an isoindolinone pigment, or a quinophthalone pigment), a dye chelate (for example, a basic dye chelate or an acidic dye chelate), a nitro pigment, a nitroso pigment, and aniline black may be used. Among these pigments, those having good affinity with a solvent are preferably used. In addition, resin hollow particles and inorganic hollow particles may also be used.

Specific examples of black pigments include carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Furthermore, examples of color pigments include C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213, C.I. Pigment Orange 5, 13, 16, 17, 36, 43, and 51, C.I. Pigment Red 1, 2, 3, 5, 17, 22, 23, 31, 38, 48:2, 48:2 (Permanent Red 2B (Ca)), 48:3, 48:4, 49:1, 52:2, 53:1, 57:1 (Brilliant Carmine 6B), 60:1, 63:1, 63:2, 64:1, 81, 83, 88, 101 (red iron oxide), 104, 105, 106, 108 (cadmium red), 112, 114, 122 (quinacridone magenta), 123, 146, 149, 166, 168, 170, 172, 177, 178, 179, 184, 185, 190, 193, 202, 207, 208, 209, 213, 219, 224, 254, and 264, C.I. Pigment Violet 1 (rhodamine lake), 3, 5:1, 16, 19, 23, and 38, C.I. Pigment Blue 1, 2, 15 (phthalocyanine blue), 15:1, 15:2, 15:3, 15:4 (phthalocyanine blue), 16, 17:1, 56, 60, and 63, and C.I. Pigment Green 1, 4, 7, 8, 10, 17, 18, and 36.

The dye is not particularly limited, and an acidic dye, a direct dye, a reactive dye, and a basic dye may be used, and one kind thereof may be used alone, or two or more kinds thereof may be used in combination.

Examples of the dye include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The content of the coloring material in the ink is preferably 0.1% by mass or more and 15% by mass or less, and more preferably 1% by mass or more and 10% by mass or less, from the viewpoint of improvement in image density, good fixability, and discharge stability.

Examples of a method to disperse the pigment to obtain the ink include a method in which a hydrophilic functional group is introduced into the pigment to obtain a self-dispersing pigment, a method in which a surface of the pigment is covered with a resin to disperse the pigment, and a method in which the pigment is dispersed using a dispersant.

Examples of the method to introduce a hydrophilic functional group into the pigment to obtain a self-dispersing pigment include a method in which a functional group such as a sulfone group or a carboxy group is added to the pigment (for example, carbon), thereby making the pigment dispersible in water.

Examples of the method to cover a surface of the pigment with a resin to disperse the pigment include a method in which the pigment is encapsulated in a microcapsule, making the pigment dispersible in water. Such a pigment can be also referred as a resin-covered pigment. In this case, the pigment blended in the ink do not need to be completely covered with the resin, and an uncovered pigment and a partially covered pigment may be dispersed in the ink within the range not impairing an effect of the present invention.

Examples of a dispersing method using a dispersant include a dispersing method using a known low molecular-type dispersant or high molecular-type dispersant typified by a surfactant.

As the dispersant, an anionic surfactant, a cationic surfactant, an amphoteric surfactant, a nonionic surfactant, or the like may be used depending on the pigment, for example.

RT-100 (nonionic surfactant) manufactured by TAKEMOTO OIL & FAT CO., LTD. or a sodium naphthalenesulfonate-formaldehyde condensate is also preferably used as the dispersant.

One kind of the dispersant may be used alone, or two or more kinds thereof may be used in combination.

### Pigment Dispersion

The ink may be obtained by mixing materials such as water, the organic solvent, and the like with the pigment. In addition, the ink may be produced by mixing materials such as water, the organic solvent, and the like with a pigment dispersion obtained by mixing the pigment and water, the dispersant, and the like.

The pigment dispersion is obtained by mixing water, the pigment, the pigment dispersant, and another component as needed, dispersing the pigment, and adjusting the particle diameter. Dispersion is preferably achieved by using a dispersing machine.

Although the particle diameter of the pigment in the pigment dispersion is not particularly limited, the particle diameter at the highest frequency in terms of the maximum number count is preferably 20 nm or more and 500 nm or less, and more preferably 20 nm or more and 150 nm or less from the viewpoints that dispersion stability of the pigment becomes good and image quality such as image density and discharge stability are also enhanced. The particle diameter of the pigment can be measured using a particle size analyzer (NANOTRAC WAVE-UT151, manufactured by MicrotracBEL Corp.).

The content of the pigment in the pigment dispersion is not particularly limited and may be appropriately selected according to a purpose, but is preferably 0.1% by mass or more and 50% by mass or less, and more preferably 0.1% by mass or more and 30% by mass or less from the viewpoints of obtaining good discharge stability and increasing image density.

It is preferable that the pigment dispersion be subjected, as necessary, to filtration with a filter, a centrifugal separator, or the like to separate coarse particles and to degassing.

### Resin

The type of the resin included in the ink is not particularly limited and may be appropriately selected according to a purpose, and examples thereof include a urethane resin, a polyester resin, an acrylic resin, a vinyl acetate-based resin, a styrene-based resin, a butadiene-based resin, a styrene-butadiene-based resin, a vinyl chloride-based resin, an acrylic styrene-based resin, and an acrylic silicone-based resin.

Resin particles formed from these resins may also be used. The ink may be obtained by mixing, with materials such as the coloring material and the organic solvent, the resin particles in a resin emulsion state in which the resin particles are dispersed with water as a dispersion medium. Resin particles synthesized as appropriate or a commercially available product may be used as the resin particles. One kind of the resin particles may be used alone, or two or more kinds thereof may be used in combination.

The volume average particle diameter of the resin particles is not particularly limited and may be appropriately selected according to a purpose, but is preferably 10 nm or more and 1,000 nm or less, more preferably 10 nm or more and 200 nm or less, and particularly preferably 10 nm or more and 100 nm or less from the viewpoints of obtaining good fixability and high image hardness.

The volume average particle diameter can be measured using a particle size analyzer (NANOTRAC WAVE-UT151, manufactured by MicrotracBEL Corp.), for example.

The content of the resin is not particularly limited and may be appropriately selected according to a purpose, but is preferably 1% by mass or more and 30% by mass or less and more preferably 5% by mass or more and 20% by mass or less with respect to the total amount of the ink from the viewpoints of fixability and ink preservation stability.

Although the particle diameter of the solid content in the ink is not particularly limited and may be appropriately selected according to a purpose, the particle diameter at the highest frequency in terms of the maximum number count is preferably 20 nm or more and 1000 nm or less, and more preferably 20 nm or more and 150 nm or less from the viewpoint of enhancing discharge stability and image quality such as image density. The solid content includes the resin particles, pigment particles, and the like. The particle diameter can be measured using a particle size analyzer (NANOTRAC WAVE-UT151, manufactured by MicrotracBEL Corp.).

### Additive

A surfactant, an antifoaming agent, an antiseptic and antifungal agent, an antirust agent, a pH adjuster, and the like may be added to the ink as necessary.

### Surfactant

As the surfactant, any of a silicone-based surfactant, a fluorine-based surfactant, an amphoteric surfactant, a nonionic surfactant, and an anionic surfactant may be used.

The silicone-based surfactant is not particularly limited and may be appropriately selected according to a purpose.

Among silicone-based surfactants, a silicone-based surfactant that does not decompose even at high pH is preferable, and examples thereof include a side-chain-modified polydimethylsiloxane, a both-end-modified polydimethylsiloxane, a one-end-modified polydimethylsiloxane, and a side-chain and both-end-modified polydimethylsiloxane. A silicone-based surfactant having a polyoxyethylene group or a polyoxyethylene-polyoxypropylene group as a modifying group is particularly preferable because such a silicone-based surfactant exhibits good properties as an aqueous surfactant. A polyether-modified silicone-based surfactant may also be used as the silicone-based surfactant, and examples thereof include a compound in which a polyalkylene oxide structure is introduced into a side chain from Si in a dimethylsiloxane.

As the fluorine-based surfactant, for example, a perfluoroalkyl sulfonic acid compound, a perfluoroalkyl carboxylic acid compound, a perfluoroalkyl phosphoric acid ester compound, a perfluoroalkyl ethylene oxide adduct, and a polyoxyalkylene ether polymer compound having a perfluoroalkyl ether group in a side chain are particularly preferable because of low foaming properties. Examples of the perfluoroalkylsulfonic acid compound include a perfluoroalkylsulfonic acid and a perfluoroalkylsulfonic acid salt. Examples of the perfluoroalkyl carboxylic acid compound include a perfluoroalkyl carboxylic acid and a perfluoroalkyl carboxylic acid salt. Examples of the polyoxyalkylene ether polymer compound having a perfluoroalkyl ether group in a side chain include a sulfuric acid ester salt of a polyoxyalkylene ether polymer having a perfluoroalkyl ether group in a side chain and a salt of a polyoxyalkylene ether polymer having a perfluoroalkyl ether group in a side chain. Examples of counter ions of salts in these fluorine-based surfactants include Li, Na, K, NH₄, NH₃ CH₂CH₂OH, NH₂ (CH₂CH₂OH) 2, and NH(CH₂CH₂OH) 3.

Examples of the amphoteric surfactant include lauryl aminopropionate, lauryl dimethyl betaine, stearyl dimethyl betaine, and lauryl dihydroxyethyl betaine.

Examples of the nonionic surfactant include a polyoxyethylene alkylphenyl ether, a polyoxyethylene alkyl ester, a polyoxyethylene alkylamine, a polyoxyethylene alkylamide, a polyoxyethylene-propylene block polymer, a sorbitan fatty acid ester, a polyoxyethylene sorbitan fatty acid ester, and an ethylene oxide adduct of acetylene alcohol.

Examples of the anionic surfactant include a polyoxyethylene alkyl ether acetate, a dodecylbenzenesulfonate, a laurylate, and a polyoxyethylene alkyl ether sulfate salt.

One kind thereof may be used alone, or two or more kinds thereof may be used in combination.

The silicone-based surfactant is not particularly limited and may be appropriately selected according to a purpose, and examples thereof include a side chain-modified polydimethylsiloxane, a both-end-modified polydimethylsiloxane, a one-end-modified polydimethylsiloxane, and a side-chain and both-end-modified polydimethylsiloxane. A polyether-modified silicone-based surfactant having a polyoxyethylene group or a polyoxyethylene-polyoxypropylene group as a modifying group is particularly preferable because such a silicone-based surfactant exhibits good properties as an aqueous surfactant.

A surfactant synthesized as appropriate or a commercially available product may be used as the surfactant. Commercially available products are available from BYK Japan KK, Shin-Etsu Chemical Co., Ltd., Toray-Dow Corning Silicone Co., Nihon Emulsion Co., Ltd., and Kyoeisha Chemical Co., Ltd., for example.

The polyether-modified silicone-based surfactant is not particularly limited and may be appropriately selected according to a purpose, and examples thereof include a compound represented by General Formula (S-1) in which a polyalkylene oxide structure is introduced into a side chain from Si in a dimethylsiloxane.

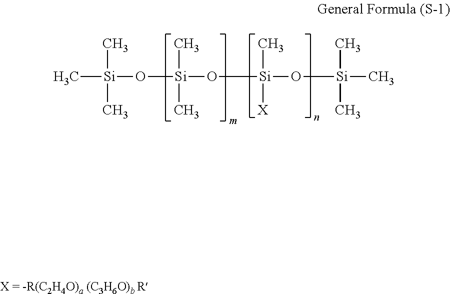

(Provided that in General Formula (S-1), m, n, a, and b each independently represent an integer, R represents an alkylene group, and R′ represents an alkyl group.)

As the polyether-modified silicone-based surfactant, a commercially available product may be used, and examples thereof include KF-618, KF-642, and KF-643 (Shin-Etsu Chemical Co.), EMALEX-SS-5602 and SS-1906EX (Nihon Emulsion Co.), FZ-2105, FZ-2118, FZ-2154, FZ-2161, FZ-2162, FZ-2163, and FZ-2164 (Toray-Dow Corning Silicone Co.), BYK-33 and BYK-387 (BYK Japan KK), and TSF4440, TSF4452, and TSF4453 (Toshiba Silicones Co., Ltd.).

As the fluorine-based surfactant, a compound in which 2 to 16 carbon atoms are substituted with fluorine atoms is preferable, and a compound in which 4 to 16 carbon atoms are substituted with fluorine atoms is more preferable.

Examples of the fluorine-based surfactant include a perfluoroalkyl phosphoric acid ester compound, a perfluoroalkyl ethylene oxide adduct, and a polyoxyalkylene ether polymer compound having a perfluoroalkyl ether group in a side chain. Among these, the polyoxyalkylene ether polymer compound having a perfluoroalkyl ether group in a side chain is preferable because of low foaming properties, and a fluorine-based surfactant represented by General Formula (F-1) and a fluorine-based surfactant represented by General Formula (F-2) are particularly preferable.

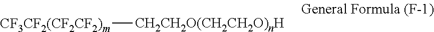

In the compound represented by General Formula (F-1), m is preferably an integer of 0 to 10, and n is preferably an integer of 0 to 40 in order to impart water solubility.

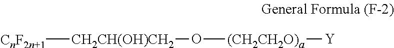

In the compound represented by General Formula (F-2), Y is H, CₘF₂ₘ₊₁, with m being an integer of 1 to 6, CH₂CH(OH)CH₂—CₘF₂ₘ₊₁, with m being an integer of 4 to 6, or CₚH₂ₚ₊₁, with p being an integer of 1 to 19; n is an integer of 1 to 6; and a is an integer of 4 to 14.

A commercially available product may be used as the fluorine-based surfactant. Examples of commercially available products of the fluorine-based surfactant include SURFLON S-111, S-112, S-113, S-121, S-131, S-132, S-141, and S-145 (all manufactured by AGC Inc.); FLUORAD FC-93, FC-95, FC-98, FC-129, FC-135, FC-170C, FC-430, and FC-431 (all manufactured by Sumitomo 3M Limited); MEGAFACE F-470, F-1405, and F-474 (all manufactured by DIC Corporation); Zonyl TBS, FSP, FSA, FSN-100, FSN, FSO-100, FSO, FS-300, UR, CAPSTONE FS-30, FS-31, FS-3100, FS-34, and FS-35 (all manufactured by The Chemours Company); FT-110, FT-250, FT-251, FT-400S, FT-150, and FT-400SW (all manufactured by NEOS Co., Ltd.), POLYFOX PF-136A, PF-156A, PF151N, PF154, and PF-159 (manufactured by OMNOVA Solutions, Inc.), and UNIDYNE DSN-403N (manufactured by DAIKIN INDUSTRIES, LTD.). Among these, FS-3100, FS-34, and FS-300 manufactured by The Chemours Company, FT-110, FT-250, FT-251, FT-400S, FT-150, and FT-400SW manufactured by NEOS Co., Ltd., POLYFOX PF-151N manufactured by OMNOVA Solutions, Inc., and UNIDYNE DSN-403N manufactured by DAIKIN INDUSTRIES, LTD. are particularly preferable from the viewpoints of good printing quality, in particular, significantly improving color developability, penetration into paper, wettability, and uniform dyeing.

The content of the surfactant in the ink is not particularly limited and may be appropriately selected according to a purpose, but is preferably 0.001% by mass or more and 5% by mass or less, and more preferably 0.05% by mass or more and 5% by mass or less from the viewpoints of excellent wettability and discharge stability and improving image quality.

### Antifoaming Agent

The antifoaming agent is not particularly limited, and examples thereof include a silicone-based antifoaming agent, a polyether-based antifoaming agent, and a fatty acid ester-based antifoaming agent. One kind thereof may be used alone, or two or more kinds thereof may be used in combination. Among these a silicone-based antifoaming agent is preferable from the viewpoint of excellent foam-breaking effect.

### Antiseptic and Antifungal Agent

The antiseptic and antifungal agent is not particularly limited, and examples thereof include 1,2-benzisothiazoline-3-one.

### Antirust Agent

The antirust agent is not particularly limited, and examples thereof include an acidic sulfite and sodium thiosulfate.

### pH Adjuster

The pH adjuster is not particularly limited as long as the pH adjuster can adjust the pH to 7 or more, and examples thereof include amines such as diethanolamine and triethanolamine.

Physical properties of the ink are not particularly limited and may be appropriately selected according to a purpose, and the viscosity, surface tension, pH, and the like of the ink are preferably within the following ranges, for example.

The viscosity of the ink at 25° C. is preferably 5 mPa's or more and 30 mPa's or less, and more preferably 5 mPa's or more and 25 mPa's or less from the viewpoints of improving print density and character quality, and providing good discharge performance. The viscosity herein can be obtained by using a rotational viscometer (RE-80L manufactured by Toki Sangyo Co., Ltd.), for example. With respect to measurement conditions, the viscosity can be measured at 25° C. using a standard cone rotor (1°34′×R24), with a sample liquid volume of 1.2 mL at a rotational speed of 50 rpm for 3 minutes.

The surface tension of the ink is preferably 35 mN/m or less and more preferably 32 mN/m or less at 25° C. from the viewpoints of suitably leveling the ink on the recording medium and shortening the ink drying time.

The pH of the ink is preferably 7 to 12 and more preferably 8 to 11 from the viewpoint of preventing corrosion of a metal member in contact with the ink.

In the ink used in the present disclosure, at least one selected from the resin and the coloring material is preferably anionic. The case where at least one selected from the resin and the coloring material is anionic is preferable because it is possible to cause the ink to aggregate or increase the viscosity of the ink when the ink is brought into contact with the pretreatment liquid containing an aggregating agent, and color developability and sharpness of the ink on a surface of the recording medium can consequently be enhanced.

### Pretreatment Liquid

The pretreatment liquid used in the present disclosure contains an aggregating agent and water and may contain, as necessary, an organic solvent, a surfactant, an antifoaming agent, a pH adjuster, an antiseptic and antifungal agent, an antirust agent, and the like. The organic solvent, surfactant, antifoaming agent, pH adjuster, antiseptic and antifungal agent, and antirust agent similar to those used for the ink may be used, and other materials used for known treatment liquids may be used.

### Aggregating Agent

Although the aggregating agent is not particularly limited, and examples thereof include a water soluble cationic polymer, an acid, and a polyvalent metal ion, a polyvalent metal ion is preferably included from the viewpoint of aggregation force of ink droplets.

As the polyvalent metal ion, known polyvalent metal ions may be appropriately selected, and examples thereof include calcium ions, magnesium ions, and aluminum ions. One kind thereof may be used alone, or two or more thereof may be used in combination.

The polyvalent metal ion can be added to the pretreatment liquid by dissolving a water soluble polyvalent metal salt.

The polyvalent metal salt may be appropriately selected from known polyvalent metal salts, and a salt of a carboxylic acid (such as acetic acid and lactic acid), a sulfuric acid salt, a nitric acid salt, a chloride, and a thiocyanic acid salt are preferable, for example. One kind of the multivalent metal salt may be used alone, or two or more kinds thereof may be used in combination. Among these, a carboxylic acid salt, a sulfuric acid salt, a nitric acid salt, and a chloride, which have good solubility in water and good solubility in a water soluble organic solvent, are preferable from the viewpoints of image quality such as color developability and bleed resistance and discharge reliability.

The content of the polyvalent metal ion in the pretreatment liquid is preferably 30 mmol/L or more and 700 mmol/L or less, more preferably 60 mmol/L or more and 500 mmol/L or less, and still more preferably 100 mmol/L or more and 400 mmol/L or less from the viewpoints of text bleeding and color developability.

The polyvalent metal ion and the content thereof can be analyzed by using ICP emission spectrometry, ion chromatography, and the like.

### Volume of Pretreatment Liquid Droplet

The volume of a droplet of the pretreatment liquid is preferably 1 pL or more and 5 pL or less, more preferably 1 pL or more and 4 pL or less, and particularly preferably 1 pL or more and 3 pL or less. When the volume of a droplet of the pretreatment liquid is 1 pL or more, the pretreatment liquid can be uniformly attached to the recording medium. When the volume of a droplet of the pretreatment liquid is 5 pL or less, deformation of an ink droplet dot when the pretreatment liquid droplet merges with an ink droplet is small, and text readability is excellent. The volumes of the pretreatment liquid droplet and the ink droplet can be appropriately adjusted by changing the driving waveform of the head.

### Attachment Amounts of Pretreatment Liquid and Ink

The amount of the pretreatment liquid attached to the recording medium is preferably 0.05 mg/cm² or more from the viewpoint of coatability of the pretreatment liquid on the recording medium, and is preferably 0.20 mg/cm² or less from the viewpoint of drying performance of the pretreatment liquid.

The amount of the ink attached to the recording medium may be appropriately adjusted according to the type of an image, but is preferably 1.0 mg/cm² or less from the viewpoints of drying performance and reactivity with the pretreatment liquid.

The amounts of the pretreatment liquid and the ink attached to the recording medium may be controlled by the volumes of the droplets, resolution of the head, the number of droplets deposited within an image, and the like.

### Resolution of Pretreatment Liquid and Ink

The resolution of the pretreatment liquid is preferably 300×300 dpi or more, more preferably 600×600 dpi or more, and particularly preferably 1200×1200 dpi or more from the viewpoint of suppressing color boundary bleeding. The above ranges are preferable because when the resolution of the pretreatment liquid falls within the above ranges, the pretreatment liquid can be uniformly attached.

The resolution of the ink is not limited, but is preferably 300×300 dpi or more and more preferably 1200×1200 dpi or more from the viewpoint of character sharpness.

The resolution of the pretreatment liquid and the resolution of the ink are preferably identical. When the resolution of the pretreatment liquid and the resolution of the ink are identical, landing-position misalignment between the pretreatment liquid and the ink can be suppressed, which is preferable for suppressing bleeding.

### Dynamic Surface Tension of Pretreatment Liquid and Ink

The pretreatment liquid and the ink according to embodiments of the present invention satisfy −5.0 mN/m≤σ1−σ2≤5.0 mN/m, where σ1 is the dynamic surface tension of the pretreatment liquid and σ2 is the dynamic surface tension of the ink as measured at 25° C. and a lifetime of 150 ms. When −5.0 mN/m≤σ1−σ2≤5.0 mN/m is satisfied, an ink droplet landing on a pretreatment liquid droplet is prevented from being drawn and diffusing into the pretreatment liquid, and text bleeding and color boundary bleeding are suppressed, enabling formation of an image with high definition.

The dynamic surface tension σ1 of the pretreatment liquid is preferably 22 mN/m or more from the viewpoint of discharge reliability, and is preferably 30 mN/m or less from the viewpoint of suppressing text bleeding. Since a pretreatment liquid droplet more rapidly penetrates and diffuses into the medium after landing as σ1 decreases, an ink droplet that lands on the pretreatment liquid droplet is not drawn in, resulting in excellent text readability.

The dynamic surface tension σ2 of the ink is not limited as long as −5.0 mN/m≤σ1 −σ2≤5.0 mN/m is satisfied, but is preferably 22 mN/m or more from the viewpoint of discharge reliability and is preferably 35 mN/m or less from the viewpoint of color developability.

The dynamic surface tensions σ1 and σ2 may be controlled by the type and amount of the solvent added, and the type and amount of the surfactant added.

The dynamic surface tensions σ1 and σ2 can be measured by using any known commonly used method, but is preferably measured by a maximum bubble pressure method in the present disclosure. A dynamic surface tension measuring instrument in the maximum bubble pressure method is commercially available, and examples thereof include DynoTester (manufactured by SITA Messtechnik GmbH).

The maximum bubble pressure method is a method in which a bubble is released from a tip of a probe immersed in a liquid to be measured, and the surface tension is determined from the maximum pressure required to release the bubble.

When the radius of the bubble becomes equal to the radius of the probe tip, the maximum pressure is reached, and the dynamic surface tension σ of the ink at this time is expressed by the following equation.

$$o = ( Δ P \cdot r ) / 2$$

In the equation, r is the radius of the probe tip, and ΔP is a difference between the maximum pressure applied to the bubble and the minimum value.

The lifetime herein refers to the time from when a bubble leaves the probe and a new surface is formed until the next maximum bubble pressure is reached in the maximum bubble pressure method.

### Posttreatment Liquid

A posttreatment liquid is not particularly limited as long as a transparent layer can be formed. The posttreatment liquid is obtained by selecting, as necessary, an organic solvent, water, a resin, a surfactant, an antifoaming agent, a pH adjuster, an antiseptic and antifungal agent, and an antirust agent, and mixing same. The posttreatment liquid may be applied over the entire recording region formed on the recording medium, or may be applied to a region where an ink image has been formed.

### Recording Medium

The recording medium is not particularly limited and may be appropriately selected according to a purpose, and examples thereof include plain paper, glossy paper, specialty paper, fabric, a film, an OHP sheet, and general-purpose printing paper.

An image-formed article obtained is of high quality, free from bleeding, and excellent in stability over time, and can be preferably used for various applications as, for example, a material on which various characters and images are recorded.

Among the recording media, from the viewpoint that an image with excellent image quality (image density, color saturation, beading, color bleeding), high glossiness, and excellent smear fixability can be recorded, general-purpose printing paper with liquid absorption characteristics within a certain range is preferable, specifically, a recording medium which has a coating layer on at least one surface of a support and in which on the surface with the coating layer, an amount of pure water transferred to the recording medium at a contact time of 100 ms is preferably 2 ml/m² or more and 35 ml/m² or less, and an amount of pure water transferred to the recording medium at a contact time of 400 ms is 3 ml/m² or more and 40 ml/m² or less as measured by a dynamic scanning liquid absorption meter is preferable.

When a recording medium in which an amount of pure water transferred is too small is used, even with the above-described ink, beading (a phenomenon in which adjacent dots attract each other, causing a mottled appearance in the image) and color bleeding (bleeding between colors) easily occur. When a recording medium in which an amount of pure water transferred is too large is used, even with the above-described ink, a diameter of ink dots after recording may become smaller than a desired diameter, and a solid image may not be fully filled.

The dynamic scanning absorptometer (DSA; Kuga, S., “Development and application of dynamic scanning absorptometer”, JAPAN TAPPI JOURNAL, Vol. 48, May 1994, pp. 88-92) is a device that can accurately measure the amount of liquid absorbed within an extremely short period of time. This dynamic scanning absorptometer automates measurement by employing the method in which (i) the liquid absorption rate is directly read from the movement of a meniscus in a capillary; (ii) a disk-shaped sample is formed, and a liquid absorption head is spirally moved in a scanning manner over the sample while automatically varying the scanning speed according to a preset pattern; and the required number of points are measured on a single sample. A head for supplying liquid to a paper sample is connected to the capillary via a TEFLON (registered trademark) tube, and the position of the meniscus in the capillary is automatically read by an optical sensor. Specifically, the amount of pure water transferred is measured using a dynamic scanning absorptometer (K350 series, model D, manufactured by Kyowa Co., Ltd.). The transfer amount at a contact time of 100 ms can be obtained by interpolation from measured transfer amount values at contact times in the vicinity of the contact time of 100 ms.

As the general-purpose printing paper with liquid absorption characteristics within a certain range, commercially available products can be used, and examples thereof include POD Gloss Coat, OK Top Coat Plus, OK Kinfuji Plus, and SA Kinfuji Plus (manufactured by Oji Paper Co., Ltd.), Super MI Dull, Aurora Coat, and Space DX (manufactured by Nippon Paper Industries Co., Ltd.), a Mat and Mu Coat (manufactured by Hokuetsu Corporation), Raicho Art and Raicho Super Art (manufactured by Chuetsu Pulp & Paper Co., Ltd.), and Pearl Coat N (manufactured by MITSUBISHI PAPER MILLS LIMITED).

In the present disclosure, the terms “image formation,” “recording,” “printing,” and “print” are used synonymously.

The terms “recording medium,” “medium,” and “print substrate” are used synonymously.

### EXAMPLES

### Preparation of Magenta Pigment Dispersion

The inside of a 1-L flask equipped with a mechanical stirrer, a thermometer, a nitrogen gas inlet tube, a reflux condenser, and a dropping funnel was sufficiently purged with nitrogen gas. Thereafter, 11.2 g of a styrene monomer (manufactured by FUJIFILM Wako Pure Chemical Corporation), 2.8 g of acrylic acid (manufactured by FUJIFILM Wako Pure Chemical Corporation), 12.0 g of lauryl methacrylate (manufactured by BASF SE), 4.0 g of polyethylene glycol dimethacrylate (manufactured by Sigma-Aldrich Japan, LLC), 4.0 g of a styrene macromer (manufactured by TOAGOSEI CO., LTD.), and 0.4 g of mercaptoethanol (manufactured by FUJIFILM Wako Pure Chemical Corporation) were mixed in the flask, and the temperature was raised to 65° C. Thereafter, a mixed solution of 100.8 g of styrene, 25.2 g of acrylic acid, 108.0 g of lauryl methacrylate, 36.0 g of polyethylene glycol dimethacrylate, 60.0 g of hydroxyethyl methacrylate (manufactured by NIPPON SHOKUBAI CO., LTD.), 36.0 g of a styrene macromer, 3.6 g of mercaptoethanol, 2.4 g of 2,2′-azobis(2,4-dimethylvaleronitrile) (95%, manufactured by FUJIFILM Wako Pure Chemical Corporation), and 18 g of methyl ethyl ketone (manufactured by FUJIFILM Wako Pure Chemical Corporation) was added dropwise into the flask over 2.5 hours.

After the dropwise addition, a mixed solution of 0.8 g of 2,2′-azobis(2,4-dimethylvaleronitrile) (95%, manufactured by FUJIFILM Wako Pure Chemical Corporation) and 18 g of methyl ethyl ketone was added dropwise into the flask over 0.5 hours. After stirring at 65° C. for 1 hour, 0.8 g of 2,2′-azobis(2,4-dimethylvaleronitrile) was added, and the mixture was further stirred for 1 hour. After completion of reaction, 364 g of methyl ethyl ketone was added into the flask to obtain 800 g of a polymer solution A with a concentration of 50% by mass.

Thereafter, 28 g of the polymer solution A, 42 g of C.I. Pigment Red 122 (manufactured by BASF SE), 13.6 g of a 1 mol/L aqueous potassium hydroxide solution (manufactured by FUJIFILM Wako Pure Chemical Corporation), 20 g of methyl ethyl ketone, and 13.6 g of ion-exchanged water were sufficiently stirred and then kneaded using a roll mill. The obtained paste (about 117 g) was added to 200 g of pure water, the mixture was sufficiently stirred, and methyl ethyl ketone and water were then distilled off using an evaporator. In order to further remove coarse particles, the dispersion liquid was subjected to pressure filtration with a polyvinylidene fluoride membrane filter (manufactured by Sigma-Aldrich Japan, LLC) having an average pore diameter of 5.0 μm to obtain a magenta pigment dispersion with a pigment solid content of 15% by mass and a total solid content of 20% by mass.

When the obtained magenta pigment dispersion was measured by NANOTRAC particle size analyzer (NANOTRAC WAVE II-UT151, manufactured by Microtrac MRB Corp.), the cumulative 50% volume particle diameter D50 was 127 nm.

### Preparation of Cyan Pigment Dispersion

A cyan pigment dispersion with a pigment solid content of 15% by mass and a total solid content of 20% by mass was prepared in the same manner as in the preparation of the magenta pigment dispersion except that C.I. Pigment Red 122 as a pigment was changed to a phthalocyanine pigment (C.I. Pigment Blue 15:3, manufactured by Dainichiseika Color & Chemicals Mfg. Co., Ltd.) in the preparation of the magenta pigment dispersion.

When polymer fine particles in the obtained cyan pigment-containing polymer fine particle dispersion liquid were measured by a particle size analyzer (NANOTRAC UPA-EX150, manufactured by NIKKISO CO., LTD.), the cumulative 50% volume particle diameter D50 was 93 nm.

### Preparation of Resin Particle Dispersion Liquid 1

A resin particle dispersion liquid 1 was synthesized by the following procedure. First, 70.0 parts of ion-exchanged water was put into a 300-mL flask equipped with a stirrer, a thermometer, a nitrogen gas inlet tube, and a reflux condenser, and the temperature was raised to 70° C. under a nitrogen flow and maintained for 2 hours. Meanwhile, 50.0 parts of methyl methacrylate, 13.0 parts of 2-ethylhexyl acrylate, 4.5 parts of vinyltriethoxysilane, 1.2 parts of AQUALON HS-10 (manufactured by DKS Co. Ltd.), and 34.4 parts of ion-exchanged water were mixed to prepare an emulsified liquid emulsified with a homomixer. Thereafter, 3.0% of a 10% AQUALON HS-10 aqueous solution and 2.1 parts of a 5% aqueous ammonium persulfate solution were added into the flask, and the emulsified liquid was then added continuously thereto in a dropwise manner over 2.5 hours. In addition, from the start of the dropwise addition until 3 hours had elapsed, 0.4 parts of a 5% aqueous ammonium persulfate solution was added every hour. After completion of the dropwise addition, the mixture was aged at 70° C. for 2 hours, cooled to room temperature, adjusted to have pH of 7 to 8 with 28% ammonia water, and adjusted to have a solid content of 30% with ion-exchanged water to obtain the resin particle dispersion liquid 1.

### Preparation of Resin Particle Dispersion Liquid 2

A resin particle dispersion liquid 2 was synthesized by the following procedure. First, 30 parts of T5651 (polycarbonate diol, manufactured by Asahi Kasei Corporation), 4.5 parts of dimethylol propionic acid, 22 parts of isophorone diisocyanate, and 49 parts of methyl ethyl ketone dehydrated by a molecular sieve were put into a 300-mL separable flask equipped with a stirrer, a thermometer, and a reflux condenser, the temperature was raised to 70° C. under a nitrogen flow, 200 ppm of tin 2-ethylhexanoate was then added, and reaction was carried out at 70° C. for 3 to 10 hours while measuring the isocyanate concentration in the system. Thereafter, the temperature in the system was decreased to 40° C., 4.8 parts of triethylamine was added, 120 parts of ion-exchanged water was then added while stirring the mixture at a rate of 300 rpm, followed by stirring for 1 hour, and 2.1 parts of diethylenetriamine was added, followed by stirring for 3 to 6 hours. Thereafter, the temperature was cooled to room temperature, the solvent was distilled off with an evaporator, and the solid content was adjusted to 30% with ion-exchanged water to obtain the resin particle dispersion liquid 2.

### Preparation of Pretreatment Liquids 1 to 13

Materials were mixed according to the preparation presented in Table 1 and stirred for 1 hour, followed by pressure filtration with a cellulose acetate membrane filter of 1.2 μm to obtain each of pretreatment liquids 1 to 13. The numbers of parts in Table 1 represent parts by mass, with the total being 100 parts by mass.

TABLE 1

| | | Active | Pretreatment liquid | | | | | | |
|---|---|---|---|---|---|---|---|---|---|
| Component | | component | 1 | 2 | 3 | 4 | 5 | 6 | 7 |
| Organic | Ethylene glycol | 100% | — | — | — | — | 5 | — | — |
| solvent | 1,2-Butanediol | 100% | 5 | 5 | 5 | 5 | — | 5 | 5 |
| | 1,2-Propanediol | 100% | 10 | 10 | 10 | 10 | 10 | 10 | 10 |
| | 3-Methoxy-1- | 100% | 5 | 5 | 5 | 5 | 5 | 5 | 5 |
| | butanol | | | | | | | | |
| | Ethylene glycol | 100% | 2 | 2 | 2 | — | 2 | 2 | 2 |
| | monomethyl ether | | | | | | | | |
| | Ethylene glycol | 100% | — | — | — | 2 | — | — | — |
| | monobutyl ether | | | | | | | | |
| Surfactant | Wet 270 | 100% | 0.1 | 0.1 | 0.1 | 0.1 | 0.1 | 0.1 | — |
| | SAG503A | 100% | 0.1 | 0.5 | 1 | 0.5 | 0.5 | — | — |
| | BYK348 | 100% | — | — | — | — | — | 0.5 | — |
| | SURFYNOL465 | 100% | — | — | — | — | — | — | 1 |
| Defoamer | 2,4,7,9- | 100% | 0.3 | 0.3 | 0.3 | 0.3 | 0.3 | 0.3 | 0.3 |
| | Tetramethyldecane- | | | | | | | | |
| | 4,7-diol | | | | | | | | |
| Aggregating | Magnesium nitrate | 100% | 17.3 | 17.3 | 17.3 | 17.3 | 17.3 | 17.3 | 17.3 |
| agent | hexahydrate | | | | | | | | |
| | Calcium nitrate | 100% | — | — | — | — | — | — | — |
| | tetrahydrate | | | | | | | | |
| | Ammonium lactate | 40% | — | — | — | — | — | — | — |
| | aqueous solution | | | | | | | | |
| | Magnesium acetate | 100% | — | — | — | — | — | — | — |
| | tetrahydrate | | | | | | | | |
| Antiseptic | Proxel GXL | 20% | 0.1 | 0.1 | 0.1 | 0.1 | 0.1 | 0.1 | 0.1 |
| agent | | | | | | | | | |

| Ion-exchanged water | Remaining | Remaining | Remaining | Remaining | Remaining | Remaining | Remaining |
|---|---|---|---|---|---|---|---|
| | amount | amount | amount | amount | amount | amount | amount |
| Dynamic surface tension σ1 [mN/m] | 30.6 | 25.8 | 23.6 | 24.5 | 26.2 | 26.9 | 30.4 |

| | | Active | Pretreatment liquid | | | | | |
|---|---|---|---|---|---|---|---|---|
| Component | | component | 8 | 9 | 10 | 11 | 12 | 13 |
| Organic | Ethylene glycol | 100% | — | — | — | — | — | — |
| solvent | 1,2-Butanediol | 100% | 5 | 5 | 5 | 5 | 5 | 5 |
| | 1,2-Propanediol | 100% | 10 | 10 | 10 | 10 | 10 | 10 |
| | 3-Methoxy-1- | 100% | 5 | 5 | 5 | 5 | 5 | 5 |
| | butanol | | | | | | | |
| | Ethylene glycol | 100% | 2 | 2 | 2 | 2 | 2 | 2 |
| | monomethyl ether | | | | | | | |
| | Ethylene glycol | 100% | — | — | — | — | — | — |
| | monobutyl ether | | | | | | | |
| Surfactant | Wet 270 | 100% | 0.1 | 0.1 | 0.1 | 0.1 | 0.1 | 0.1 |
| | SAG503A | 100% | 0.5 | 0.5 | 0.5 | 0.5 | 0.5 | 0.5 |
| | BYK348 | 100% | — | — | — | — | — | — |
| | SURFYNOL465 | 100% | — | — | — | — | — | — |
| Defoamer | 2,4,7,9- | 100% | 0.3 | 0.3 | 0.3 | 0.3 | 0.3 | 0.3 |
| | Tetramethyldecane- | | | | | | | |
| | 4,7-diol | | | | | | | |
| Aggregating | Magnesium nitrate | 100% | 1.7 | 8.6 | 26 | — | — | — |
| agent | hexahydrate | | | | | | | |
| | Calcium nitrate | 100% | — | — | — | 14.4 | — | — |
| | tetrahydrate | | | | | | | |
| | Ammonium lactate | 40% | — | — | — | — | 20 | — |
| | aqueous solution | | | | | | | |
| | Magnesium acetate | 100% | — | — | — | — | — | 15.1 |
| | tetrahydrate | | | | | | | |
| Antiseptic | Proxel GXL | 20% | 0.1 | 0.1 | 0.1 | 0.1 | 0.1 | 0.1 |
| agent | | | | | | | | |

| Ion-exchanged water | Remaining | Remaining | Remaining | Remaining | Remaining | Remaining |
|---|---|---|---|---|---|---|
| | amount | amount | amount | amount | amount | amount |
| Dynamic surface tension σ1 [mN/m] | 26 | 26 | 25.7 | 26 | 25.8 | 26 |

### Preparation of Inks 1 to 8

Materials were mixed according to the preparation presented in Table 2 and stirred for 1 hour, followed by pressure filtration with a cellulose acetate membrane filter of 1.2 μm to obtain each of inks 1 to 8. The numbers of parts in Table 2 represent parts by mass, with the total being 100 parts by mass.

TABLE 2

| | | Active | Ink | | | |
|---|---|---|---|---|---|---|
| Component | | component | 1 | 2 | 3 | 4 |
| Organic | Ethylene glycol | 100% | — | — | — | — |
| solvent | 1,2-Butanediol | 100% | 5 | 5 | 5 | 5 |
| | 1,2-Propanediol | 100% | 10 | 10 | 10 | 10 |
| | 3-Methoxy-1-butanol | 100% | 5 | 5 | 5 | 5 |
| | Ethylene glycol | 100% | 2 | 2 | 2 | — |
| | monomethyl ether | | | | | |
| | Ethylene glycol | 100% | — | — | — | 2 |
| | monobutyl ether | | | | | |
| Surfactant | Wet 270 | 100% | 0.1 | 0.1 | 0.1 | 0.1 |
| | SAG503A | 100% | 0.1 | 0.5 | 1 | 0.5 |
| | BYK348 | 100% | — | — | — | — |
| | SURFYNOL465 | 100% | — | — | — | — |
| Defoamer | 2,4,7,9-Tetramethyldecane-4,7-diol | 100% | 0.3 | 0.3 | 0.3 | 0.3 |
| Pigment | Cyan pigment dispersion | 15% | 26.7 | 26.7 | 26.7 | 26.7 |
| dispersion | Magenta pigment dispersion | 15% | — | — | — | — |
| Resin | Resin particle dispersion liquid 1 | 30% | 30 | 30 | 30 | 30 |
| particle | Resin particle dispersion liquid 2 | 30% | 2.5 | 2.5 | 2.5 | 2.5 |
| dispersion | | | | | | |
| liquid | | | | | | |
| Wax | AQUACER 531 | 45% | 2.2 | 2.2 | 2.2 | 2.2 |
| Antiseptic | Proxel GXL | 20% | 0.1 | 0.1 | 0.1 | 0.1 |
| agent | | | | | | |
| Ion-exchanged water | | | Remaining | Remaining | Remaining | Remaining |
| | | | amount | amount | amount | amount |
| Dynamic surface tension σ2 [mN/m] | | | 32.5 | 28.2 | 25.8 | 24 |
| | | Active | Ink | | | |
| Component | | component | 5 | 6 | 7 | 8 |
| Organic | Ethylene glycol | 100% | — | — | — | — |
| solvent | 1,2-Butanediol | 100% | 5 | 5 | 5 | 5 |
| | 1,2-Propanediol | 100% | 10 | 10 | 10 | 10 |
| | 3-Methoxy-1-butanol | 100% | 5 | 5 | 5 | 5 |
| | Ethylene glycol | 100% | 2 | 2 | 2 | — |
| | monomethyl ether | | | | | |
| | Ethylene glycol | 100% | — | — | — | 2 |
| | monobutyl ether | | | | | |
| Surfactant | Wet 270 | 100% | 0.1 | 0.1 | 0.1 | 0.1 |
| | SAG503A | 100% | 0.1 | 0.5 | 1 | 0.5 |
| | BYK348 | 100% | — | — | — | — |
| | SURFYNOL465 | 100% | — | — | — | — |
| Defoamer | 2,4,7,9-Tetramethyldecane-4,7-diol | 100% | 0.3 | 0.3 | 0.3 | 0.3 |
| Pigment | Cyan pigment dispersion | 15% | — | — | — | — |
| dispersion | Magenta pigment dispersion | 15% | 26.7 | 26.7 | 26.7 | 26.7 |
| Resin | Resin particle dispersion liquid 1 | 30% | 30 | 30 | 30 | 30 |
| particle | Resin particle dispersion liquid 2 | 30% | 2.5 | 2.5 | 2.5 | 2.5 |
| dispersion | | | | | | |
| liquid | | | | | | |
| Wax | AQUACER 531 | 45% | 2.2 | 2.2 | 2.2 | 2.2 |
| Antiseptic | Proxel GXL | 20% | 0.1 | 0.1 | 0.1 | 0.1 |
| agent | | | | | | |

| Ion-exchanged water | Remaining | Remaining | Remaining | Remaining |
|---|---|---|---|---|
| | amount | amount | amount | amount |
| Dynamic surface tension σ2 [mN/m] | 32.4 | 27.8 | 25.4 | 23.4 |

Note that details of the surfactants and the antiseptic agent used to prepare the pretreatment liquids and the inks are as follows.
Wet270: polyether-modified siloxane compound (manufactured by Evonik Industries AG)
SAG503A: polyether-modified siloxane compound (manufactured by Nissin Chemical Industry Co., Ltd.)
BYK348: polyether-modified siloxane compound (manufactured by BYK Japan KK)
SURFYNOL465: acetylene glycol compound (manufactured by Nissin Chemical Industry Co., Ltd.)
Proxel GXL: fungicide (manufactured by Avecia)

### Measurement of Dynamic Surface Tension

The dynamic surface tension of each of the inks 1 to 8 and pretreatment liquids 1 to 13 was measured by a portable surface tension meter (manufactured by EKO INSTRUMENTS CO., LTD., SITA DynoTester) at a temperature of 25° C. and a bubble life time of 15 msec.

### Examples 1 to 22 and Comparative Examples 1 and 2

Using the pretreatment liquid and the inks presented in Table 3, printing was performed by the method described below, and text readability and color boundary bleeding were evaluated.

A printing sample was obtained using an apparatus in which the pretreatment liquid and the inks are configured as inkjet application units in the image forming apparatus illustrated in the drawing. Note that OK Top Coat Plus (basis weight: 128 g/m²) manufactured by Oji Paper Co., Ltd. was used as the medium.

The landing time difference between the pretreatment liquid and the inks was adjusted by changing the media conveyance speed and the driving frequency of the head, and the droplet volume of the pretreatment liquid was adjusted by the driving waveform.

### Text Readability

The prepared inks and pretreatment liquid for each example were loaded into the image forming apparatus illustrated in the drawing, and a Gothic outline character chart of 2 to 5 pt was printed under the conditions described in Table 3. The text readability of the obtained image was assessed by naked eyes and visually evaluated according to the following criteria, with images rated 3 or higher being regarded as acceptable.

### Evaluation Criteria

5: A 2-pt character is readable.

4: A 2-pt character is not readable, but a 3-pt character is readable.

3: A 3-pt character is not readable, but a 4-pt character is readable.

2: A 4-pt character is not readable, but a 5-pt character is readable.

1: A 5-pt character is not readable.

### Color Boundary Bleeding

The prepared inks and pretreatment liquid for each example were loaded into the image forming apparatus illustrated in the drawing, and solid image printing was performed under conditions where the ink resolution was 1200×1200 dpi, the ink attachment amount was 0.5 μL/cm², and conditions for the pretreatment liquid were as described in Table 3 so that the cyan and magenta inks were placed adjacent to each other. Thereafter, the degree of color boundary bleeding was assessed by naked eyes and visually evaluated according to the following criteria, with images rated 3 or higher being regarded as acceptable.

### Evaluation Criteria

5: There is no color boundary bleeding.

4: There is slight color boundary bleeding.

3: There is color boundary bleeding.

2: There is significant color boundary bleeding.

1: There is color boundary bleeding more severe than 2.

TABLE 3

| | Printing conditions | | | | |
|---|---|---|---|---|---|
| | Landing time difference (s) | | Pretreatment | Volume of | |
| | Pretreatment | Pretreatment | Liquid | pretreatment | |
| | liquid- | liquid- | resolution | liquid droplet | |
| | cyan ink | magenta ink | [dpi] | [pL] | Pretreatment liquid |
| Example 1 | 0.1 | 0.2 | 1200 × 1200 | 2 | Pretreatment liquid 1 |
| Example 2 | 0.1 | 0.2 | 1200 × 1200 | 2 | Pretreatment liquid 2 |
| Example 3 | 0.1 | 0.2 | 1200 × 1200 | 2 | Pretreatment liquid 3 |
| Example 4 | 0.1 | 0.2 | 1200 × 1200 | 2 | Pretreatment liquid 4 |
| Example 5 | 0.1 | 0.2 | 1200 × 1200 | 2 | Pretreatment liquid 5 |
| Example 6 | 0.1 | 0.2 | 1200 × 1200 | 2 | Pretreatment liquid 6 |
| Example 7 | 0.1 | 0.2 | 1200 × 1200 | 2 | Pretreatment liquid 7 |
| Example 8 | 0.1 | 0.2 | 1200 × 1200 | 2 | Pretreatment liquid 8 |
| Example 9 | 0.1 | 0.2 | 1200 × 1200 | 2 | Pretreatment liquid 9 |
| Example 10 | 0.1 | 0.2 | 1200 × 1200 | 2 | Pretreatment liquid 10 |
| Example 11 | 0.1 | 0.2 | 1200 × 1200 | 2 | Pretreatment liquid 11 |
| Example 12 | 0.1 | 0.2 | 1200 × 1200 | 2 | Pretreatment liquid 12 |
| Example 13 | 0.1 | 0.2 | 1200 × 1200 | 2 | Pretreatment liquid 13 |
| Example 14 | 0.1 | 0.2 | 1200 × 1200 | 2 | Pretreatment liquid 2 |
| Example 15 | 0.1 | 0.2 | 1200 × 1200 | 2 | Pretreatment liquid 2 |
| Example 16 | 0.1 | 0.2 | 600 × 600 | 2 | Pretreatment liquid 2 |
| Example 17 | 0.1 | 0.2 | 300 × 300 | 2 | Pretreatment liquid 2 |
| Example 18 | 0.1 | 0.2 | 1200 × 1200 | 4 | Pretreatment liquid 2 |
| Example 19 | 0.1 | 0.2 | 1200 × 1200 | 6 | Pretreatment liquid 2 |
| Example 20 | 0.5 | 1 | 1200 × 1200 | 2 | Pretreatment liquid 2 |
| Example 21 | 1 | 2 | 1200 × 1200 | 2 | Pretreatment liquid 2 |
| Example 22 | 2 | 4 | 1200 × 1200 | 2 | Pretreatment liquid 2 |
| Comparative | 0.1 | 0.2 | 1200 × 1200 | 2 | Pretreatment liquid 1 |
| example 1 | | | | | |
| Comparative | 0.1 | 0.2 | 1200 × 1200 | 2 | Pretreatment liquid 3 |
| example 2 | | | | | |

| | Printing conditions | | | | Evaluation | |
|---|---|---|---|---|---|---|
| | | | σ1 − σ2 | | | Color |
| | Ink | Ink | [mN/m] | | Text | boundary |
| | (cyan) | (magenta) | Cyan | Magenta | readability | bleeding |
| Example 1 | Ink 2 | Ink 6 | 2.4 | 2.8 | 3 | 5 |
| Example 2 | Ink 2 | Ink 6 | −2.4 | −2.0 | 5 | 5 |
| Example 3 | Ink 2 | Ink 6 | −4.6 | −4.2 | 3 | 3 |
| Example 4 | Ink 2 | Ink 6 | −3.7 | −3.3 | 4 | 4 |
| Example 5 | Ink 2 | Ink 6 | −2.0 | −1.6 | 4 | 5 |
| Example 6 | Ink 2 | Ink 6 | −1.3 | −0.9 | 4 | 5 |
| Example 7 | Ink 2 | Ink 6 | 2.2 | 2.6 | 3 | 5 |
| Example 8 | Ink 2 | Ink 6 | −2.2 | −1.8 | 4 | 3 |
| Example 9 | Ink 2 | Ink 6 | −2.2 | −1.8 | 4 | 5 |
| Example 10 | Ink 2 | Ink 6 | −2.5 | −2.1 | 5 | 5 |
| Example 11 | Ink 2 | Ink 6 | −2.2 | −1.8 | 4 | 5 |
| Example 12 | Ink 2 | Ink 6 | −2.4 | −2.0 | 5 | 3 |
| Example 13 | Ink 2 | Ink 6 | −2.2 | −1.8 | 4 | 5 |
| Example 14 | Ink 3 | Ink 7 | 0.0 | 0.4 | 5 | 5 |
| Example 15 | Ink 4 | Ink 8 | 1.8 | 2.4 | 5 | 5 |
| Example 16 | Ink 3 | Ink 7 | 0.0 | 0.4 | 5 | 4 |
| Example 17 | Ink 3 | Ink 7 | 0.0 | 0.4 | 5 | 3 |
| Example 18 | Ink 3 | Ink 7 | 0.0 | 0.4 | 4 | 5 |
| Example 19 | Ink 3 | Ink 7 | 0.0 | 0.4 | 3 | 5 |
| Example 20 | Ink 3 | Ink 7 | 0.0 | 0.4 | 5 | 5 |
| Example 21 | Ink 3 | Ink 7 | 0.0 | 0.4 | 5 | 5 |
| Example 22 | Ink 3 | Ink 7 | 0.0 | 0.4 | 5 | 5 |
| Comparative | Ink 4 | Ink 8 | 6.6 | 7.2 | 1 | 2 |
| example 1 | | | | | | |
| Comparative | Ink 1 | Ink 5 | −8.9 | −8.8 | 2 | 2 |
| example 2 | | | | | | |

From the results of Examples 1 to 22, it is found that by using a combination of a pretreatment liquid and an ink satisfying-5.0 mN/m≤σ1−σ2≤5.0 mN/m, color boundary bleeding and text bleeding can be suppressed even in high-speed printing in which the landing time difference between a pretreatment liquid droplet and an ink droplet is within 2 seconds.

On the other hand, from the results of Comparative Examples 1 and 2, it is found that in the case of σ1−σ2<−5.0 mN/m or σ1−σ2>5.0 mN/m, color boundary bleeding and text bleeding are caused in high-speed printing.

Exemplary aspects of the present invention are as follows.

In Aspect 1, an image forming method includes discharging a pretreatment liquid and an ink onto a recording medium by an inkjet method to form an image, in which
the pretreatment liquid includes an aggregating agent,
a landing time difference between a droplet of the pretreatment liquid and a droplet of the ink is 0.05 seconds or more and 2.0 seconds or less, and
−5.0 mN/m≤σ1−σ2≤5.0 mN/m is satisfied, where σ1 is the dynamic surface tension of the pretreatment liquid and σ2 is the dynamic surface tension of the ink as measured at 25° C. and a lifetime of 150 ms.

According to Aspect 2, in the image forming method of Aspect 1, the dynamic surface tension σ1 is 22 mN/m or more and 30 mN/m or less.

According to Aspect 3, in the image forming method of Aspect 1 or Aspect 2 the droplet of the pretreatment liquid has a volume of 1 pL or more and 5 pL or less.

According to Aspect 4, in the image forming method of any one of Aspect 1 to Aspect 3, the aggregating agent includes a polyvalent metal ion.

According to Aspect 5, in the image forming method of any one of Aspect 1 to Aspect 4, the pretreatment liquid and the ink have the same resolution.

In Aspect 6, an image forming apparatus includes: a head to discharge a pretreatment liquid; and a head to discharge an ink,
in which the image forming apparatus discharges the pretreatment liquid and the ink onto a recording medium by an inkjet method to form an image,
the pretreatment liquid includes an aggregating agent,
a landing time difference between a droplet of the pretreatment liquid and a droplet of the ink is 0.05 seconds or more and 2.0 seconds or less, and
−5.0 mN/m≤σ1−σ2≤5.0 mN/m is satisfied, where σ1 is the dynamic surface tension of the pretreatment liquid and 2 is the dynamic surface tension of the ink as measured at 25° C. and a lifetime of 150 ms.

The image forming methods of Aspect 1 to Aspect 5 and the image forming apparatus of Aspect 6 can solve the problems in related art and achieve an object of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image forming method comprising:
discharging a pretreatment liquid and an ink onto a recording medium by an inkjet method to form an image,
wherein the pretreatment liquid includes an aggregating agent,
a landing time difference between a droplet of the pretreatment liquid and a droplet of the ink is 0.05 seconds or more and 2.0 seconds or less, and
−5.0 mN/m≤σ1−σ2≤5.0 mN/m is satisfied, where σ1 is a dynamic surface tension of the pretreatment liquid and σ2 is a dynamic surface tension of the ink as measured at 25° C. and a lifetime of 150 ms.

2. The image forming method according to claim 1, wherein the dynamic surface tension σ1 is 22 mN/m or more and 30 mN/m or less.

3. The image forming method according to claim 1, wherein the droplet of the pretreatment liquid has a volume of 1 pL or more and 5 pL or less.

4. The image forming method according to claim 1, wherein the aggregating agent includes a polyvalent metal ion.

5. The image forming method according to claim 1, wherein the pretreatment liquid and the ink have the same resolution.

6. An image forming apparatus comprising:
a head to discharge a pretreatment liquid on a recording medium by an inkjet method; and
a head to discharge an ink on the recording medium by an inkjet method to form an image,
wherein the pretreatment liquid includes an aggregating agent,
a landing time difference between a droplet of the pretreatment liquid and a droplet of the ink is 0.05 seconds or more and 2.0 seconds or less, and
−5.0 mN/m≤σ1-σ2≤5.0 mN/m is satisfied, where σ1 is a dynamic surface tension of the pretreatment liquid and σ2 is a dynamic surface tension of the ink as measured at 25° C. and a lifetime of 150 ms.
